(19) United States
(12) Patent Application Publication
(10) Pub. No.: US 2006/0190136 A1
(43) Pub. Date: Aug. 24, 2006

(54) Method and system for controlling a manipulator

(75) Inventor: Bradley R. Boyer, Troy, MI (US)

Correspondence Address: BROOKS KUSHMAN P.C., 1000 TOWN CENTER, TWENTY-SECOND FLOOR, SOUTHFIELD, MI, 48075, US

(73) Assignee: Paragon Technical Services, Inc., Clawson, MI (US)

(21) Appl. No.: 11/349,706

(22) Filed: Feb. 8, 2006

Related U.S. Application Data
(60) Provisional application No. 60/655,739, filed on Feb. 24, 2005.

(51) Int. Cl. G06F 19/00

(52) U.S. Cl. 700/245

(57) ABSTRACT

A method of planning a path for a multi-axis machine. The method includes specifying kinematic limits for each axis of the multi-axis machine, breaking the path into a sequence of linear moves, and deriving a jerk pulse array for each axis for each move.

### CROSS-REFERENCE TO RELATED APPLICATIONS

This application claims the benefit of U.S. provisional application Serial No. 60/655,739 filed Feb. 24, 2005.

### BACKGROUND OF THE INVENTION

1. Field of the Invention

The present invention relates to a method and a system for controlling a manipulator, such as a multi-axis robot.

2. Background Art

Previous methods for controlling electrical motors of a multi-axis industrial machine are known in the art, such as that disclosed in U.S. Pat. No. 5,923,132.

### SUMMARY OF THE INVENTION

In at least one embodiment of the present invention, a method of planning a path for a multi-axis machine is provided. The method includes specifying kinematic limits for each axis of the multi-axis machine, breaking the path into a sequence of linear moves, each move within a three-dimensional space, and deriving a jerk pulse array for each axis for each move. The jerk pulse array specifies a set of segments within the move.

In at least one other embodiment of the present invention, a method of path planning is provided. The method includes specifying axis parameters for each axis of a multiple axis machine, specifying a closed path as a sequence of moves for the multiple axis machine, specifying a move overlap percentage for each pair of adjacent moves, aligning an acceleration profile for each axis for each move in the sequence of moves, and overlapping for at least one axis a deceleration portion for a first move in the sequence of moves with an acceleration portion for a next move following the first move based on the move overlap percentage for the first move and the next move.

In at least one other embodiment of the present invention, a computer-readable medium storing a program executable by a computer for planning a path for a multi-axis machine is provided. The medium includes a move stacking code segment for breaking the path into a sequence of linear moves, a jerk pulse code segment for generating a jerk pulse array having data for a set of segments that define each move, a move overlapping code segment for overlapping at least one move in the sequence of linear moves with a next move in the sequence of linear moves such that an acceleration of at least one axis in a next move occurs at the same time as deceleration of at least one axis in a previous move, a path normalization code segment for normalizing the sequence of linear moves, and a generating code segment for generating a fmal array of path points for each axis.

### BRIEF DESCRIPTION OF THE DRAWINGS

FIG. 1 is a schematic diagram of an exemplary system for controlling a manipulator.

FIGS. 2-9 are flowcharts of a method for controlling a manipulator in accordance with the present invention.

FIGS. 10-15 are graphical representations of various aspects of the present invention.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

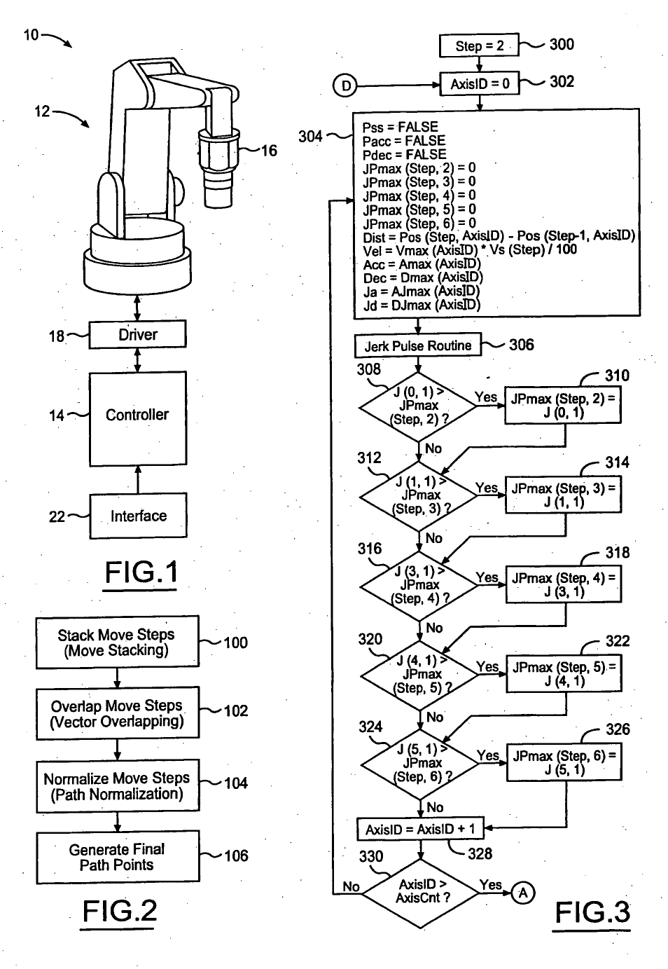

Referring to FIG. 1, a schematic of an exemplary control system 10 for a manipulator 12 is shown. The control system may include one or more control modules or controllers 14. In FIG. 1, one controller is shown for simplicity. The controller 14 may have any suitable configuration and may be of any suitable type, such as a microprocessor-based system like as a computer or a programmable logic controller (PLC).

The manipulator 12 may be of any suitable type and may have any suitable configuration. For example, the manipulator 12 may be configured as a robot adapted to move along a plurality of axes. For simplicity, graphical representations of the invention shown in FIGS. 10-14 will be described with reference to an embodiment having two axes. It should be understood that the present invention also contemplates embodiments that have any number of desired axes or degrees of freedom.

The manipulator 12 may include one or more end effectors at an end of an arm of the manipulator 12. The end effector may be of any suitable type, such as a tool or material handling device like a gripper.

The controller 14 may be adapted to control operation of the manipulator 12. For example, the controller 14 may control operation of one or more actuating devices 16, such as servo motors associated with the manipulator 12. The actuating devices 16 may be of any suitable type and may be configured to effect movement of an aspect of the manipulator 12, such as translational or rotational movement along or about an axis.

The controller 14 may be connected to drivers 18 associated with one or more actuating devices 16. In at least one embodiment, an individual motor driver may control the current provided to an associated servo motor based on commands from the controller 14. As such, the motor driver 18 may control the rotational velocity of a servo motor or similar actuating device 16.

The controller 14 may receive signals from the manipulator 12 and/or actuating devices 16 that are indicative of their operational status. More specifically, the controller 14 may receive signals from one or more components, sensors, or feedback devices associated the manipulator 12. For example, a feedback device, such as an encoder, may be associated with an actuating device 16 or manipulator axis and may provide a signal indicative of axis position and/or the position or rotation of the actuating device 16.

The controller 14 may also communicate with various input devices. For example, the controller may communicate with a user interface 22 that facilitates manual interfacing with the controller 14. The user interface 22 may be of any suitable type, such as a keyboard, touch screen, or data entry pendant.

The control system 10 of the present invention may execute a control program to control actuation of the manipulator 12. More specifically, the control program may control actuation of the manipulator 12 along or about each axis to position the end effector and accomplish one or more tasks at predetermined locations. A control program may utilize a “path recipe” or path planning table that includes positioning data. In operation, the control system 10 may move the manipulator from point to point in a sequential manner. The points or positioning data may be expressed as a plurality of vectors or vector endpoints that may be preprogrammed or entered by an operator. The vectors or vector endpoints may be based on any suitable coordinate system, such as Cartesian (X,Y,Z) or spherical coordinates. An exemplary path planning table for a six-axis manipulator is shown in Table A.

TABLE A

| A | Ax0 | Ax1 | Ax2 | Ax3 | Ax4 | Ax5 |
|---|---|---|---|---|---|---|
| 0 | Pos(0, 0) | Pos(0, 1) | Pos(0, 2) | Pos(0, 3) | Pos(0, 4) | Pos(0, 4) |
| 1 | Pos(1, 0) | Pos(1, 1) | Pos(1, 2) | Pos(1, 3) | Pos(1, 4) | Pos(1, 4) |
| 2 | Pos(2, 0) | Pos(2, 1) | Pos(2, 2) | Pos(2, 3) | Pos(2, 4) | Pos(2, 4) |
| 3 | Pos(3, 0) | Pos(3, 1) | Pos(3, 2) | Pos(3, 3) | Pos(3, 4) | Pos(3, 4) |
| 4 | Pos(4, 0) | Pos(4, 1) | Pos(4, 2) | Pos(4, 3) | Pos(4, 4) | Pos(4, 4) |
| i | Pos(i, 0) | Pos(i, 1) | Pos(i, 2) | Pos(i, 3) | Pos(i, 4) | Pos(I, 4) |
| . . . | . . . | . . . | . . . | . . . | . . . | . . . |
| k | Pos(k, 0) | Pos(k, 1) | Pos(k, 2) | Pos(k, 3) | Pos(k, 4) | Pos(k, 4) |

where:
i is an index number that is an integer between 0 and k,
k is an integer associated with the last move point in the path (and k+1 is the total number of move points for at least one axis in the path), and
Pos(i,B) is a vector end position coordinate, where B is the axis number.

In Table A, the axes are designated Ax0 (axis 0) through Ax5 (axis 5). A vector endpoint or end position coordinate is associated with each axis and each “move” or step along the path. More specifically, the path traversed by the manipulator may include k+1 “moves” where each move has a target endpoint coordinate (vector endpoint) associated with each axis.

In addition, the path planning table may also include velocity attributes and vector overlap attributes as shown in Table B.

TABLE B

| A | Vs | Vo |
|---|---|---|
| 0 | Vs(0) | Vo(0) |
| 1 | Vs(1) | Vo(1) |
| 2 | Vs(2) | Vo(2) |
| 3 | Vs(3) | Vo(3) |
| 4 | Vs(4) | Vo(4) |
| i | Vs(i) | Vo(i) |
| . . . | . . . | . . . |
| m | Vs(m) | Vo(m) |

where:
i is an index number that is an integer between 0 and m,
m is an integer associated with the last move point,
Vs(i) is the maximum velocity or speed at which a vector associated with move number i is traversed, and
Vo(i) is a vector overlap value associated with move number i.

The Vs and Vo values may be expressed as percentages. Vs may not be less than approximately 1% and may not exceed the maximum performance of the hardware associated with a particular axis (100%). For instance, the Vs values may be in the range of 25% to 100%. Similarly, Vo may be between 0% (no overlap) and 100% (maximum overlap). The vector overlap attribute is indicative of the amount or percentage of overlap of the deceleration and acceleration phases of sequential move vectors and is described in more detail below.

The control system 10 may also utilize data indicative of performance parameters of the manipulator 12. These performance parameters may be based on kinematic attributes or kinematic limits of the manipulator 12, such as velocity, acceleration, and deceleration attributes associated with each axis. For instance, these kinematic attributes may be maximum values associated with the performance limits of the hardware and may be independently established for each manipulator axis. An exemplary listing of kinematic attributes for a six-axis manipulator is shown in Table C.

TABLE C

| Ax# | Vmax | Amax | AJmax | Dmax | DJmax |
|---|---|---|---|---|---|
| 0 | Vmax(0) | Amax(0) | AJmax(0) | Dmax(0) | DJmax(0) |
| 1 | Vmax(1) | Amax(1) | AJmax(1) | Dmax(1) | DJmax(1) |
| 2 | Vmax(2) | Amax(2) | AJmax(2) | Dmax(2) | DJmax(2) |
| 3 | Vmax(3) | Amax(3) | AJmax(3) | Dmax(3) | DJmax(3) |
| 4 | Vmax(4) | Amax(4) | AJmax(4) | Dmax(4) | DJmax(4) |
| 5 | Vmax(5) | Amax(5) | AJmax(5) | Dmax(5) | DJmax(5) |

where:
Ax# is the axis number (an integer between 0 and n, where n+1 is the total number of axes),
Vmax(n) is the maximum velocity for axis n (in in/s or deg/s),
Amax(n) is the maximum acceleration for axis n (in in/s/s or deg/s/s),
AJmax(n) is the maximum acceleration phase jerk for axis n (in in/s/s/s or deg/sisis),
Dmax(n) is the maximum deceleration for axis n (in in/s/s or deg/s/s), and
DJmax(n) is the maximum deceleration phase jerk for axis n (in in/s/s/s or deg/s/s/s).

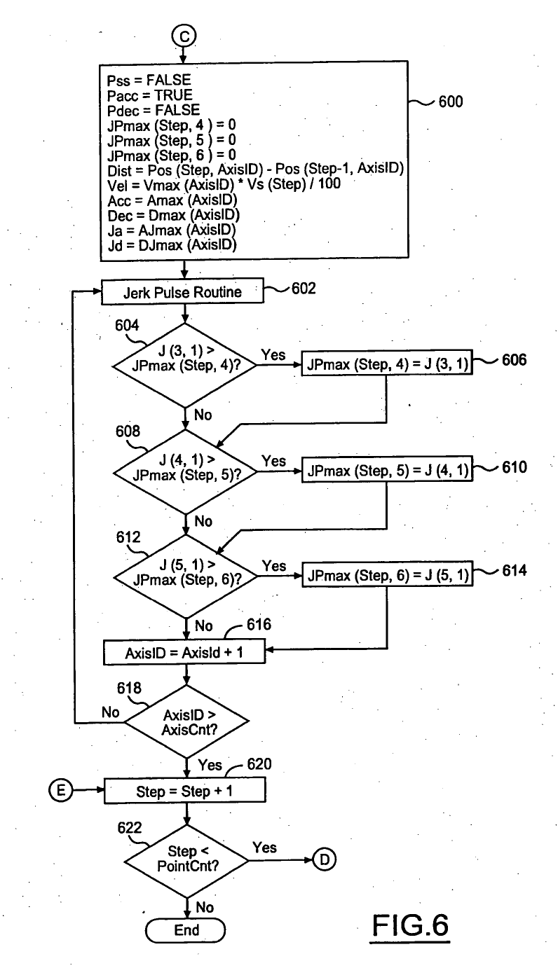

Referring to FIGS. 2-9, flowcharts depicting a method for controlling operation of a manipulator are shown. As will be appreciated by one of ordinary skill in the art, the flowchart represents control logic which may be implemented using hardware, software, or combination of hardware and software. For example, the various functions may be performed using a programmed microprocessor. The control logic may be implemented using any of a number of known programming or processing techniques or strategies and is not limited to the order or sequence illustrated. For instance, interrupt or event-driven processing is employed in real-time control applications, rather than a purely sequential strategy as illustrated. Likewise, pair processing, multitasking, or multi-threaded systems and methods may be used to accomplish the objectives, features, and advantages of the present invention.

This invention is independent of the particular programming language, operating system processor, or circuitry used to develop and/or implement the control logic illustrated. Likewise, depending upon the particular programming language and processing strategy, various functions may be performed in the sequence illustrated at substantially the same time or in a different sequence while accomplishing the features and advantages of the present invention. The illustrated functions may be modified or in some cases omitted without departing from the spirit or scope of the present invention.

Referring to FIG. 2, a main or summary flowchart of the method is shown. The present invention determines a path recipe that minimizes or reduces the total time needed to traverse the path. The method may utilize the maximum acceleration and deceleration rates associated with the manipulator hardware to reduce the total traverse time. In addition, the method permits the amount of move step overlap to be adjusted to reduce the duration of deceleration and subsequent acceleration phases, thereby maintaining a higher average velocity along the path.

At 100, the method begins by “stacking” or lining up the move steps (vectors) for each axis, designated “move stacking” herein. A detailed flowchart of the move stacking steps is depicted in FIG. 3 and is described in more detail below.

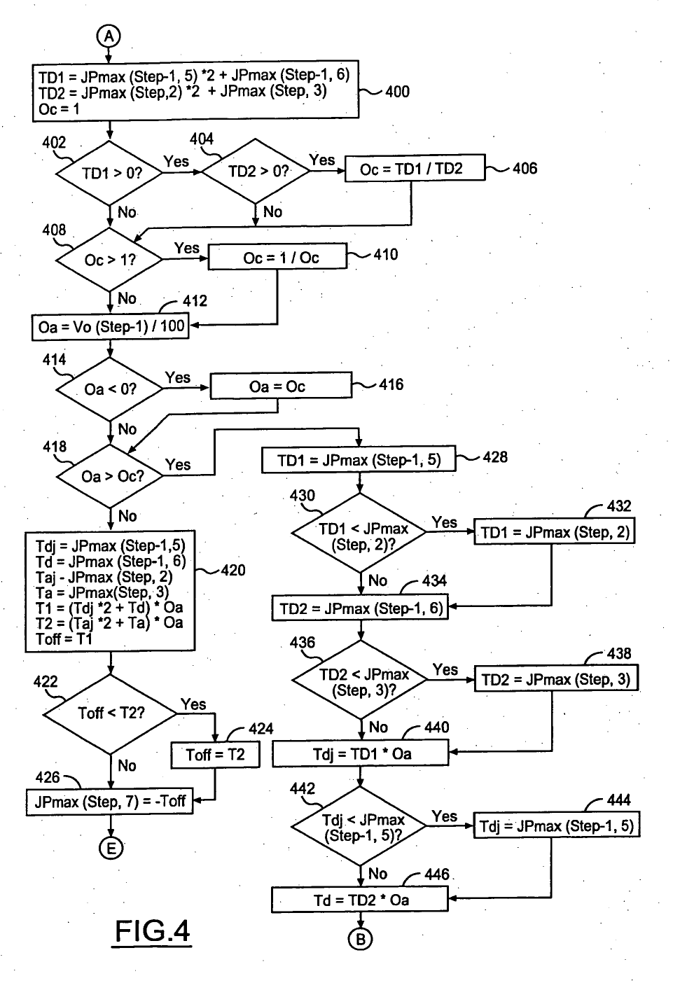

At 102, the move steps (vectors) are overlapped when possible to reduce or eliminate the deceleration and subsequent acceleration between sequential move steps. Detailed flowcharts of the vector overlapping steps are shown in FIGS. 4-6.

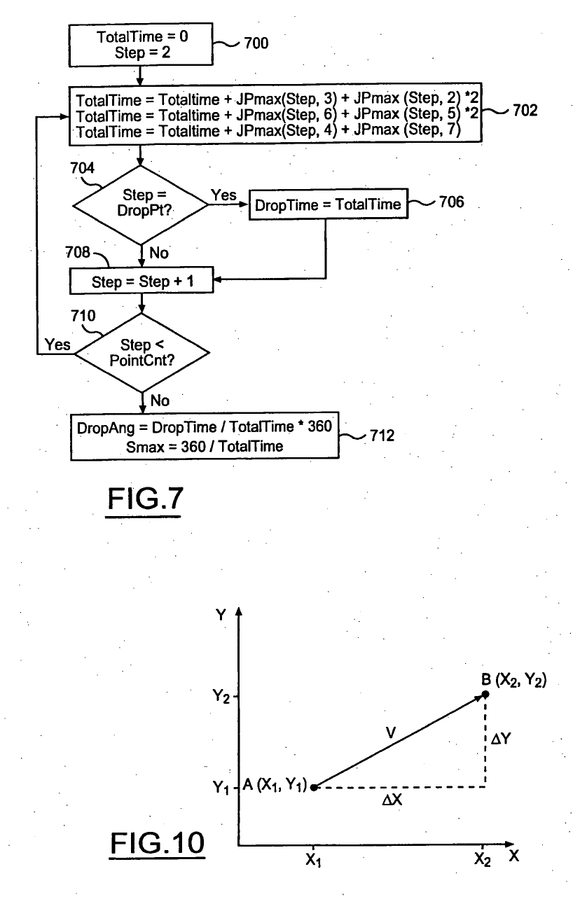

At 104, the overlapped move steps are normalized (referred to as “path normalization”) to determine the total time required to execute the sequence of moves in the path. A detailed flowchart of the path normalization steps is depicted in FIG. 7.

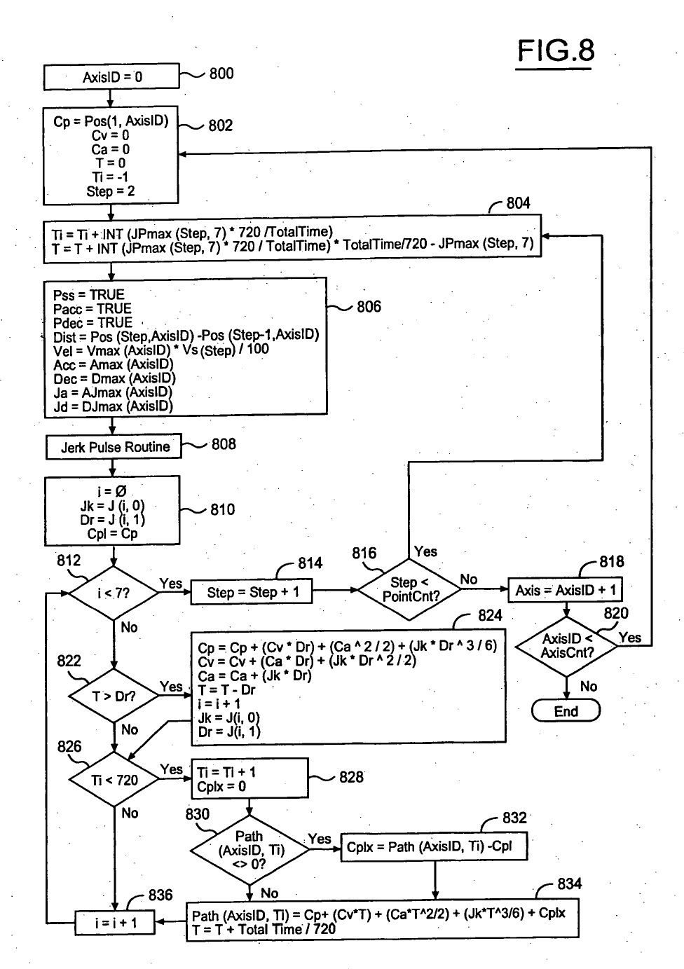

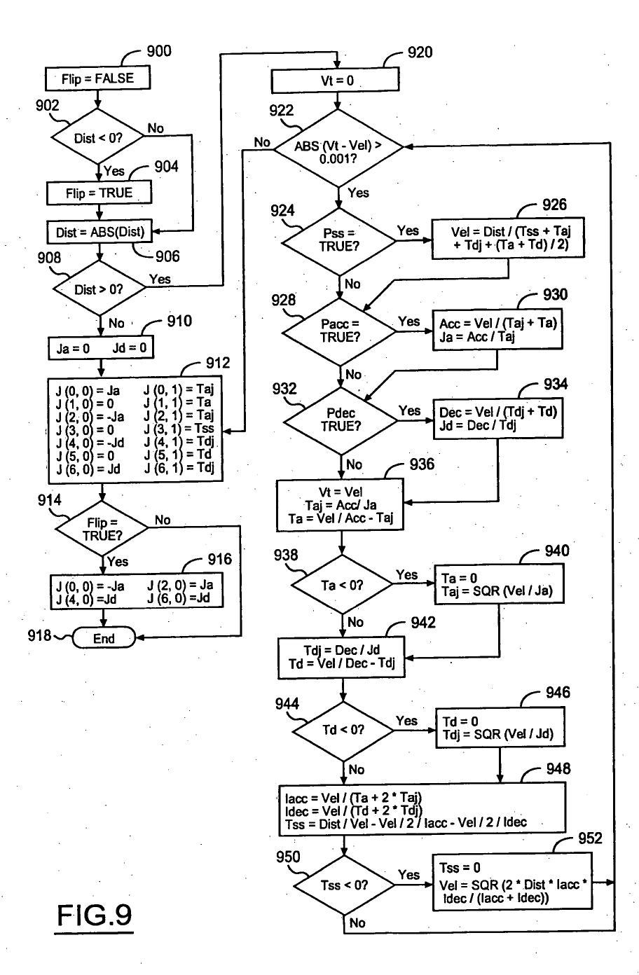

At 106, a final array of path points is generated. The final array is based on “jerk pulse” arrays previously generated during the stacking and overlapping steps associated with blocks 100 and 102. A detailed flowchart of the final array generation steps is depicted in FIG. 8. A “jerk pulse routine” or steps associated with generating a jerk pulse array are shown in FIG. 9.

Before discussing the method steps in detail, an overview of move stacking and vector overlapping is provided with reference to FIGS. 10-15.

FIG. 10 graphically depicts a two exemplary points in space, designated A and B. For simplicity, these points will be described in a two-dimensional context; however, additional dimensions and/or different axes may be provided for these or any other similar points. The coordinates for point A are (X₁, Y₁). The coordinates for point B are (X₂, Y₂). A vector that describes the move between points A and B is designated by arrowed line V. To execute a move from A to B, the manipulator is actuated along the X and Y axes. More specifically, the distance traversed along the X axis is designated ΔX and the distance traversed along the Y axis is designated ΔY. Actuation along these axes may occur simultaneously.

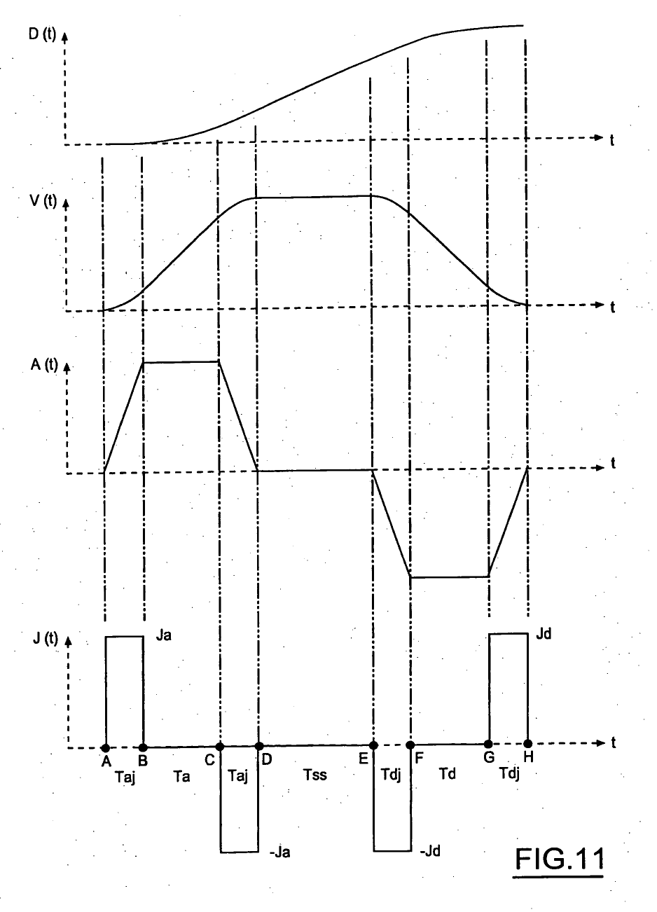

Referring to FIG. 11, actuation along an axis, such as the X axis, is shown in more detail. Similar graphical depictions may be generated for other axes. FIG. 11 includes four plots. From top to bottom, these plots depict displacement (D), velocity (V), acceleration (A), and impulse or jerk pulse (J) profiles along a common horizontal time axis (t). The horizontal time axis includes seven segments that are summarized in Table D.

TABLE D

| Segment | Start Point | End Point | Time (length) | J(t) |
|---|---|---|---|---|
| 0 | A | B | Taj [=J(0, 1)] | Ja [=J(0, 0)] |
| 1 | B | C | Ta [=J(1, 1)] | 0 [=J(1, 0)] |
| 2 | C | D | Taj [=J(2, 1)] | −Ja [=J(2, 0)] |
| 3 | D | E | Tss [=J(3, 1)] | 0 [=J(3, 0)] |
| 4 | E | F | Tdj [=J(4, 1)] | −Jd [=J(4, 0)] |
| 5 | F | G | Td [=J(5, 1)] | 0 [=J(5, 0)] |
| 6 | G | H | Tdj [=J(6, 1)] | Jd [=J(6, 0)] |

As shown in Table D, each segment has a start point and an end point designated by letters A through H in FIG. 11. Moreover, segment 0 and segment 2 have the same time duration or length (Taj) as do segment 4 and segment 6 (Tdj). In addition, each time duration value is associated with an array value shown in the format “J(n,1)” where n is the axis number (here n=1 for convenience). These array values correspond to the nomenclature used in the flowcharts.

Table D also shows jerk pulse values [J(t)] associated with each segment. The jerk pulse values may also be referred to as jerk values. These jerk pulse values are shown graphically along the vertical axis of the jerk pulse plot. Each jerk pulse value is associated with an array value shown in the format “J(n,0)” that corresponds to the nomenclature used in the flowcharts. In addition, Ja and −Ja may be the same or different than Jd and −Jd, respectively.

The segments may be characterized in terms of their acceleration/deceleration jerk and/or velocity characteristics. For example, segment 0 may be characterized as having a positive acceleration jerk as is best shown in the bottom plot of FIG. 11. Segment 1 may be characterized as having a constant acceleration dwell. Segment 2 may be characterized as having a negative acceleration jerk. Segment 3 may be characterized as having a constant velocity dwell. Segment 4 may be characterized as having a negative deceleration jerk. Segment 5 may be characterized as having a constant deceleration dwell. Segment 7 may be characterized as having a positive deceleration jerk. In addition, at least one of segments 0, 1 and 2 may be characterized as an acceleration portion of a move or move vector while at least one of segments 4, 5, and 6 may be characterized as a deceleration portion of a move or a move vector.

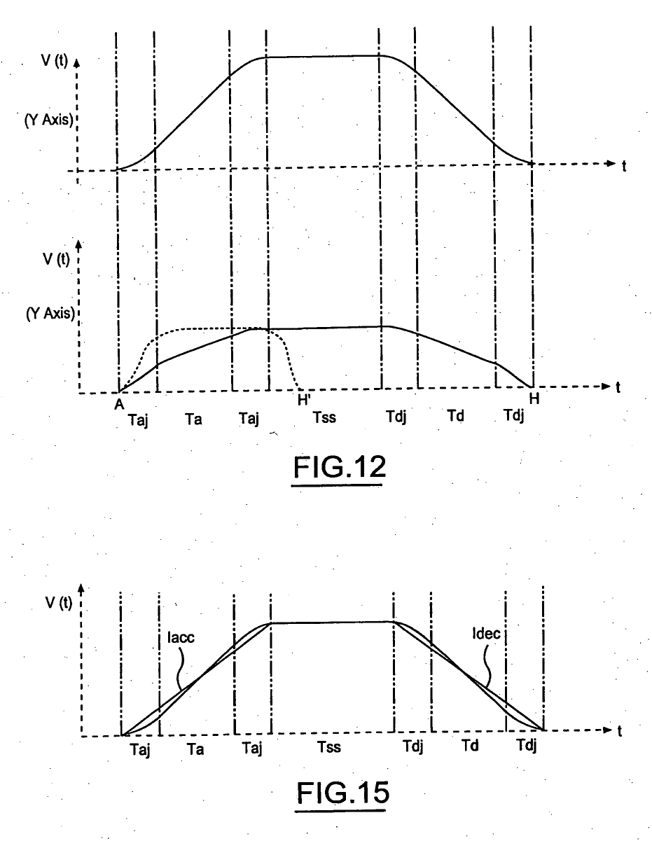

With the background information presented above, the concept of “stacking” may be illustrated. In FIG. 12 the velocity plot from FIG. 11 (associated with the X axis) is reproduced. In addition, a velocity plot associated with the Y axis is shown. The Y axis velocity plot includes a dashed line and a solid line. The dashed line depicts the Y axis velocity before adjustment. The solid line depicts the Y axis velocity after adjustment. Both the dashed and solid lines have seven segments, similar to the X axis velocity line (for convenience, the segments for the dashed line are not explicitly labeled). However, the dashed line has a shorter duration and does not “line up” with the X axis velocity line. These differences may be due to different traverse distances (e.g., ΔX≠ΔY) and/or different hardware performance attributes associated with each axis (e.g., different maximum acceleration, deceleration, and/or velocity rates).

To account for these differences, the stacking methodology adjusts or “stretches” one or more segments so that each segment for each axis has the same length (duration). In FIG. 12, the solid line in the Y axis velocity plot reflects these adjustments. To create an adjusted or “stretched” line, the longest time value is selected for each segment. For example, the unadjusted length of segment 0 along the time axis is determined for each axis (i.e., each velocity plot). The largest segment 0 distance is selected and the segment 0 lengths for each axis are adjusted as needed to attain a common segment length. These steps are repeated for the remaining segments, resulting in velocity plots scaled by segment to attain a common total time duration for each axis for a common vector. As such, the endpoint of the unadjusted dashed line (H′) becomes adjusted endpoint H after the segment lengths are adjusted.

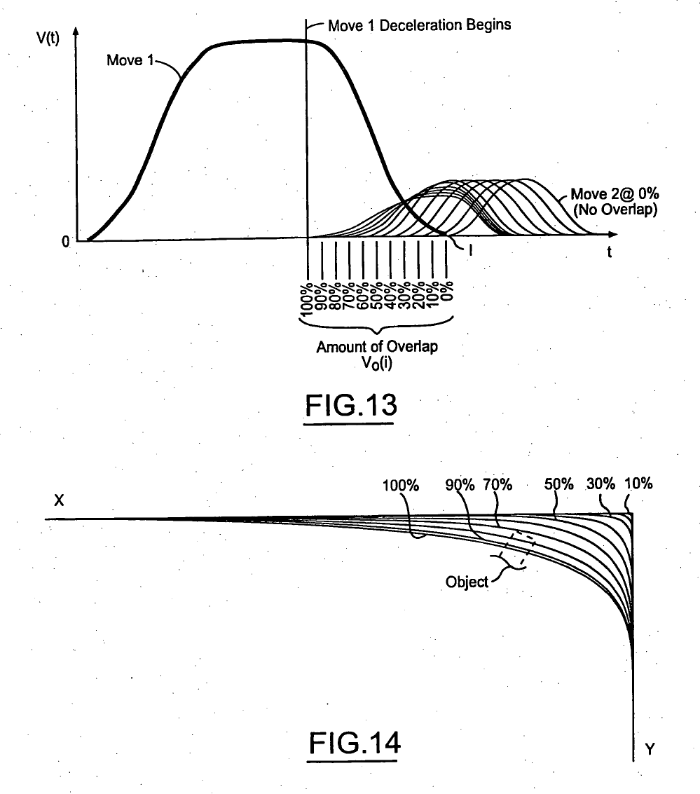

Referring to FIGS. 12-13, vector overlapping is shown graphically. As previously discussed, each move has an associated velocity plot for each axis (such as axes X and Y shown in FIG. 12). In FIG. 13, a velocity plot for a first move (Move 1) is represented by the thick line. Similarly, a velocity plot for a second move (Move 2) is represented by the thin lines. More specifically, the thin lines for Move 2 are shown with various exemplary amounts of overlap, ranging from 0% to 100%. If there is no overlap (i.e., 0% overlap) the endpoint of Move 1 coincides with the start point of Move 2, designated point I. At 0% overlap, the velocity is zero at point I.

Sequential moves, such as Move 1 and Move 2, may be overlapped such that at least a portion of the deceleration segments (e.g., segments 4-6) of a prior move (e.g., Move 1) overlap at least a portion of the acceleration segments (e.g., segments 0-2) of the next move (e.g., Move 2). Curves depicting various amounts of overlap are shown in FIG. 13. The percent overlap is represented by the parameter Vo, discussed above in association with Table B. As Vo increases, the total amount of time needed to traverse from point to point (e.g., from the start of Move 1 to the end of Move 2) is reduced since the velocity increases (at the point where Move 1 intersects Move 2) as the amount of overlap increases.

Referring to FIG. 14, a graphical representation of the overlap effect along multiple axes is shown. For simplicity, a two dimensional plot is depicted. In FIG. 14, different exemplary amounts of overlap (i.e., 10%, 20%, 30%, 40%, 50%, 60%, 70%, 80%, 90%, 100%) as shown as solid lines. A constant amount of overlap is applied to each axis at a given path point to maintain common scaled time durations (as discussed above with reference to move stacking). As the amount of overlap increases, apparent radius of each curve (i.e., each overlap line) increases. In addition, the amount of deceleration also decreases as the apparent radius increases (i.e., the average velocity increases at overlap increases).

The amount of overlap (Vo) or may be selected to avoid interference with one or more objects that may be encountered while traversing the path. In this exemplary plot, an object (represented by dashed lines) is shown that may interfere with the traverse of the manipulator. In this plot, an amount of overlap less than approximately 70% will result in no interference (i.e., curves associated with an overlap of approximately 70% or less do not intersect the object). Similarly, an amount of overlap greater than approximately 70% results in interference with the object (i.e., curves associated with an overlap that exceeds 70% intersect the object).

FIG. 14 indicates that high overlap values, such as 100%, may not minimize traverse time. For example, if maximum overlap (100%) is employed, actuation along or about one or more axes may not allow the manipulator to avoid an object (e.g., the manipulator may need to stop movement or decelerate significantly along one or more axes while movement continues along other axes to avoid an interference condition). As a result, the present invention teaches that partial overlap (less than 100%) may result in lower traverse times (and a higher average velocity) than a constant overlap value for all sequential moves, such as maximum overlap (100%). In addition, wear on manipulator components may be reduced since the present invention may reduce the magnitude and/or duration of sequential deceleration and acceleration events, such as deceleration and acceleration events associated with avoiding an object. Also, overlapping in accordance with one or more embodiments of the present invention may help conserve power. For instance, less energy may be needed to accelerate a motor if it is not stopped or decelerated significantly to avoid an interference condition. In addition, in a common DC drive motor controller using regenerative braking technology, energy recovered or regenerated from a decelerating motor may be stored in a suitable device (e.g., a capacitor) and may be used to accelerate or power a motor.

Referring again to FIGS. 3-9, flowcharts of a method for controlling operation of a manipulator are shown in more detail. For convenience in reference, the first digit of each step coincides with the number of the figure in which that step is shown (e.g., each step in FIG. 3 begins with the number 3, each step in FIG. 4 begins with the number 4, etc.).

In accordance with various embodiments of the present invention, the methods are intended for operation as software programs running on a processor, such as a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

The software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Starting with FIG. 3, a flowchart of method steps associated with move stacking (lining up move vectors for each axis) is shown.

At 300, the method begins by selecting step number two (Step=2), which corresponds with the endpoint of the second vector in the sequence of move steps.

At 302, an axis is selected. More specifically, the axis number (AxisID) is initialized to a first axis, which in this example is referenced as axis number zero.

At 304, other variables are initialized. These variables may include Boolean variables associated with the automatic calculation of various time values. More specifically, Pss, Pacc, and Pdec are associated with the automatic calculation of velocity steady state time, acceleration time, and deceleration time values, respectively. If Pss if false, calculation of a velocity steady state time value is permitted. If Pss is true, a predetermined steady state time value (Tss) is employed. Similarly, if Pacc if false, calculation of an acceleration time value is permitted. If Pacc is true, a predetermined acceleration time value (Ta) is employed. Likewise, if Pdec if false, calculation of a deceleration time value is permitted. If Pdec is true, a predetermined deceleration time value (Td) is employed.

Step 304 also initializes an array of maximum jerk pulse values. More specifically, the maximum jerk pulse value associated with Taj for the current move step is set equal to zero [JPmax(Step,2)=0], the maximum jerk pulse value associated with Ta for the current move step is set equal to zero [JPmax(Step,3)=0], the maximum jerk pulse value associated with Tss for the current move step is set equal to zero [JPmax(Step,4)=0], the maximum jerk pulse value associated with Tdj for the current move step is set equal to zero [JPmax(Step,5)=0], and the maximum jerk pulse value associated with Td for the current move step is set equal to zero [JPmax(Step,6)=0].

An axis move distance (e.g., ΔX, ΔY, ΔZ etc.) for the current move, designated “Dist” is determined for the selected axis by subtracting the position of the end point of the previous move vector [Pos(Step−1,AxisID)] from the end point of the current move vector [Pos(Step,AxisID)]. The end point of the previous move vector is equivalent to the start point for the current move vector.

A maximum velocity value (Vel) for the current move and selected axis is determined by multiplying the maximum velocity for the current axis [Vmax(AxisID)] by the maximum velocity associated with the current vector expressed as a percentage [(Vs(Step)/100].

An axis maximum acceleration value for the current move (Acc) is set equal to the maximum acceleration value for the selected axis [Amax(AxisID)].

An axis maximum deceleration value for the current move (Dec) is set equal to the maximum deceleration value for the selected axis [Dmax(AxisID)].

An axis maximum acceleration jerk value for the current move (Ja) is set equal to the maximum attainable acceleration phase jerk value for the selected axis [AJmax(AxisID)].

An axis maximum deceleration jerk value for the current move (Jd) is set equal to the maximum attainable deceleration phase jerk value for the selected axis [DJmax(AxisID)].

At 306, the jerk pulse routine may be executed to update values in the jerk pulse array. The jerk pulse array and its current values may be accessed to provide data for subsequent steps.

At 308, Taj [which corresponds with J(0,1) as shown in Table D] is compared to an associated maximum jerk pulse value for the current move step [JPmax(Step,2)]. If Taj exceeds JPmax(Step,2), then JPmax(Step,2) is set equal to Taj at block 310. Otherwise, the method continues at block 312.

At 312, Ta [=J(1,1)] is compared to an associated maximum jerk pulse value for the current move step [JPmax(Step,3)]. If Ta exceeds JPmax(Step,3), then JPmax(Step,3) is set equal to Ta at block 314. Otherwise, the method continues at block 316.

At 316, Tss [=J(3,1)] is compared to an associated maximum jerk pulse value for the current move step [JPmax(Step,4)]. If Tss exceeds JPmax(Step,4), then JPmax(Step,4) is set equal to Tss at block 318. Otherwise, the method continues at block 320.

At 320, Tdj [ =J(4,1)] is compared to an associated maximum jerk pulse value for the current move step [JPmax(Step,5)]. If Tdj exceeds JPmax(Step,5), then JPmax(Step,5) is set equal to Tdj at block 322. Otherwise, the method continues at block 324.

At 324, Td [=J(5,1)] is compared to an associated maximum jerk pulse value for the current move step [JPmax(Step,6)]. If Td exceeds JPmax(Step,6), then JPmax(Step,6) is set equal to Td at block 326. Otherwise, the method continues at block 328.

At 328, the axis number is incremented.

At 330, the axis number is compared to the total number of axes (AxisCnt). If the axis number does not exceed the total number of axes, then the method returns to block 304 where values are determined for the newly selected axis. If the axis number exceeds the total number of axes, then the method continues at block 400 on FIG. 4.

Referring to FIGS. 4-6, a flowchart of method steps associated with overlapping move steps or move vectors is shown.

At 400, a deceleration time value for the previous move (TD1), an acceleration time for the currently selected move (TD2), and a critical overlap value (Oc) are determined.

The deceleration time for the previous move (TD1) is the sum of its Tdj and Td time segments. Since there are two Tdj time segments in a given move, the Tdj value [JPmax(Step−1,5)] is multiplied by two in block 400.

The acceleration time for the selected move (TD2) is the sum of its Taj and Ta time segments. Since there are two Taj time segments in a given move, the Taj value [JPmax(Step−1,2)] is multiplied by two in block 400.

The critical overlap value (Oc) is a value between 0 and 1 and corresponds with the percent overlap of the current and previous move. More specifically, a value of zero corresponds with an overlap of 0% while a value of one corresponds with an overlap of 100%. Block 400 initializes the overlap at 100%.

At 402, the deceleration time value for the previous move is assessed. If TD1 is greater than zero, then the method continues at block 404. If TD1 is not greater than zero, then the method continues at block 408.

At 404, the acceleration time value for the selected move is assessed. If TD2 is greater than zero, then the method continues at block 406. If TD2 is not greater than zero, then the method continues at block 408.

At 406, the critical overlap value (Oc) is set equal to the ratio of TD1 to TD2. This may result in a critical overlap value of less than 100%.

At 408, the critical overlap value (Oc) is assessed. If Oc is greater than one, then the method continues at block 410. If Oc is not greater than one, then the method continues at block 412.

At 410, the critical overlap value is set equal to its reciprocal value (1/Oc).

At 412, an actual overlap value (Oa) is deternined. The actual overlap value is a value between 0 and 1 and corresponds with the percent overlap of the current and previous move. More specifically, a value of zero corresponds with an actual overlap of 0% while a value of one corresponds with an actual overlap of 100%. Initially, Oa is set equal to the vector overlap value for the previous move [Vo(Step−1)] expressed as a percentage.

At 414, the actual overlap value is assessed. If Oa is less than zero (i.e., Vo(Step−1) is a negative value), then Oa is set equal to the critical overlap value (Oc) at block 416. If Oa is not less than zero, then the method continues at block 418.

At 418, the actual overlap value is reassessed. If Oa is greater than Oc, then the method continues at block 428. If Oa is not greater than Oc, then the method continues at block 420.

At 420, various time values are updated. Deceleration time values Td and Tdj are set equal to the corresponding time values for the previous move. Acceleration time values Ta and Taj are set equal to the corresponding time values for the current move. An overlap time value for the previous move (T1) is set equal to the total deceleration time (Tdj*2+Td) multiplied by the actual offset value (Oa). An overlap time value for the selected move is set equal to the total acceleration time (Taj*2+Ta) multiplied by the actual offset value (Oa). A time offset value is set equal to T1.

At 422, the method determines whether T1 is greater than T2. More specifically, the method determines whether Toff (which was set equal to T1 in block 420) is less than T2. If Toff is less than T2 (i.e., T1<T2), then Toff is set equal to T2 at block 424. If Toff is not less than T2 (i.e., T1≮T2), then the method continues at block 426.

At 426, JPmax(Step,7) is set equal to the negative value of Toff (i.e., −Toff).

At 428, the assessment of move step overlapping begins. First, the deceleration time for the previous move (TD1) is set equal to the Tdj for the previous move [JPmax(Step−1,5)].

At 430, Tdj for the previous move and Taj for the selected move are compared and the larger value is selected. More specifically, TD1 is compared to Taj for the selected move. If TD1 is less than JPmax(Step,2), (i.e., Taj for the current move>Tdj for the previous move), then TD1 is set equal to JPmax(Step,2) at block 432 (i.e., TD1=Taj for the current move). If TD1 is not less than JPmax(Step,2), (i.e., Taj for the current move is not less than Tdj for the previous move), then TD1 remains equal to Tdj and the method continues at block 434.

At 434, the overlap time for the next move (TD2) is set equal to Td for the previous move [JPmax(Step−1,6)].

At 436, Td for the previous move and Ta for the selected move are compared and the larger value is selected. More specifically, TD2 is compared to Ta for the selected move. If TD2 is less than JPmax(Step,3), (i.e., Ta for the current move>Td for the previous move), then TD2 is set equal to JPmax(Step,3) at block 438 (i.e., TD2=Ta for the current move). If TD2 is not less than JPmax(Step,3), (i.e., Ta for the current move is not less than Td for the previous move), then TD2 remains equal to Td and the method continues at block 440.

At 440, the method begins to determnine specific segment adjustment amounts. First, Tdj is set equal to TD1 multiplied by the actual overlap amount (Oa).

At 442, Tdj is compared with the Tdj value for the previous move. If Tdj is less than Tdj for the previous move [Tdj<JPmax(Step−1,5)], then Tdj is set equal to Tdj for the previous move at block 444. If Tdj is not less than Tdj for the previous move, then the method continues at block 446.

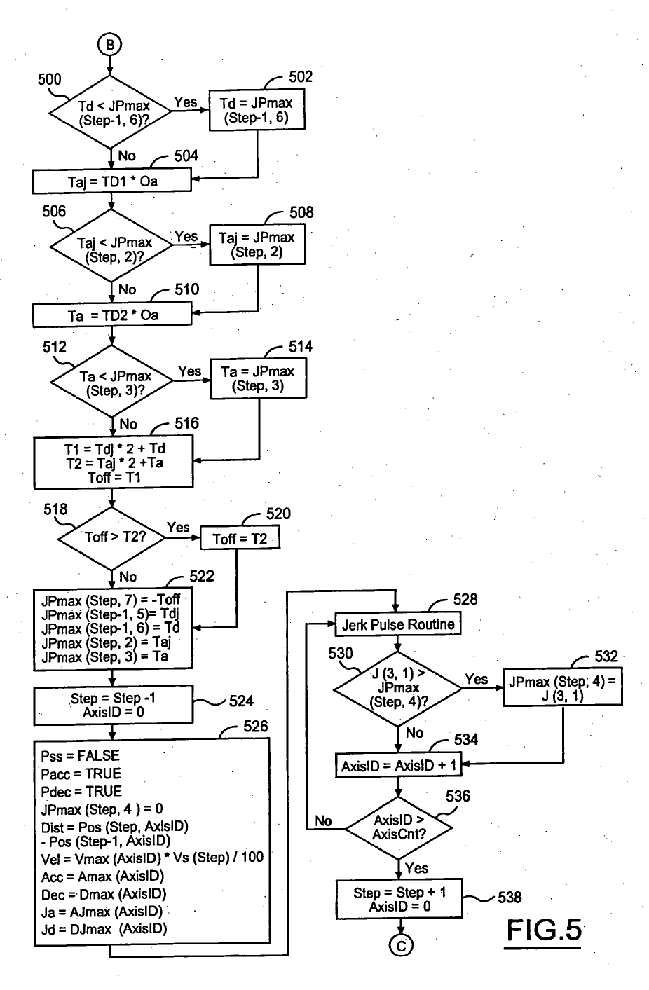

At 446, Td is set equal to TD2 multiplied by the actual overlap amount (Oa). The method continues at block 500 on FIG. 5.

At 500, Td is compared with the Td value for the previous move. If Td is less than Td for the previous move [Td<JPmax(Step−1,6)], then Td is set equal to Td for the previous move at block 502. If Td is not less than Td for the previous move, then the method continues at block 504.

At 504, Taj is set equal to TD1 multiplied by the actual overlap amount (Oa).

At 506, Taj is compared with the Taj value for the next move. If Taj is less than Taj for the next move [Taj<JPmax(Step,2)], then Taj is set equal to Taj for the next move at block 508. If Taj is not less than Taj for the next move, then the method continues at block 510.

At 510, Ta is set equal to TD2 multiplied by the actual overlap amount (Oa).

At 512, Ta is compared with the Ta value for the next move. If Ta is less than Ta for the next move [Ta<JPmax(Step,3)], then Ta is set equal to Ta for the next move at block 514. If Ta is not less than Ta for the next move, then the method continues at block 516.

At 516, various time values are updated in a manner similar to block 420. The overlap time value for the previous move (T1) is set equal to the total deceleration time (Tdj*2+Td) multiplied by the actual offset value (Oa). An overlap time value for the selected move is set equal to the total acceleration time (Taj*2+Ta) multiplied by the actual offset value (Oa). A time offset value is set equal to T1.

At 518, the method determines whether T1 is less than T2. More specifically, the method determines whether Toff (which was set equal to T1 in block 516) is greater than T2. If Toff is greater than T2 (i.e., T1>T2), then Toff is set equal to T2 at block 520. If Toff is not greater than T2 (i.e., T1≯T2), then the method continues at block 522.

At 522, various time parameters are updated based on the updated values for Ta, Taj, Td, and Tdj established in blocks 440 through 514.

At 524, the previous step is selected for analysis and the axis number is set to the first axis, here axis 0.

At 526, various variable values are set. This block is similar to block 304 except (1) automatic calculations are permitted for Pacc and Pdec and (2) time values are not reset except for Tss [JPmax(Step,4) =0].

At 528, the jerk pulse routine may be executed to update values in the jerk pulse array. The jerk pulse array and its current values may be accessed to provide data for subsequent steps as in block 306.

At 530, a maximum value for Tss checked. More specifically, Tss [=J(3,1)] is compared to an associated maximum jerk pulse value for the current move step [JPmax(Step,4)]. If Tss is greater than JPmax(Step,4), then JPmax(Step,4) is set equal to Tss at block 532. Otherwise, the method continues at block 534.

At 534, the axis number is incremented.

At 536, the axis number is compared to the total number of axes (AxisCnt). If the axis number does not exceed the total number of axes, then the method returns to block 528 where the maximum value for Tss is checked for the newly selected axis. If the axis number exceeds the total number of axes (i.e., all axes have been checked), then the method continues at block 538.

At 538, the step number is incremented and the axis number is set to the first axis, here axis 0.

At 600, various variable values are set. This block is similar to block 304 except (1) automatic calculations are permitted for Pacc and (2) time values are reset only for Tss [JPmax(Step,4)=0], Tdj [JPmax(Step,5)=0], and Td [JPmax(Step,6) =0].

At 602, the jerk pulse routine may be executed to update values in the jerk pulse array. The jerk pulse array and its current values may be accessed to provide data for subsequent steps as in blocks 306 and 528.

At 604, Tss [=J(3,1)] is compared to an associated maximum jerk pulse value for the current move step [JPmax(Step,4)]. If Tss exceeds JPmax(Step,4), then JPmax(Step,4) is set equal to Tss at block 606. Otherwise, the method continues at block 608.

At 608, Tdj [=J(4,1)] is compared to an associated maximum jerk pulse value for the current move step [JPmax(Step,5)]. If Tdj exceeds JPmax(Step,5), then JPmax(Step,5) is set equal to Tdj at block 610. Otherwise, the method continues at block 612.

At 612, Td [=J(5,1)] is compared to an associated maximum jerk pulse value for the current move step [JPmax(Step,6)]. If Td exceeds JPmax(Step,6), then JPmax(Step,6) is set equal to Td at block 614. Otherwise, the method continues at block 616.

At 616, the axis number is incremented.

At 618, the axis number is compared to the total number of axes (AxisCnt). If the axis number does not exceed the total number of axes, then the method returns to block 602 where values are determined for the newly selected axis. If the axis number exceeds the total number of axes, then the method continues at block 620.

At 620, the step number is incremented.

At 622, the step number is compared to the total number of steps or points in the move path (PointCnt). If there are more points in the move path, then the method returns to block 302. If there are no more points in the move path, then overlapping of the move steps is complete.

Referring to FIG. 7, a flowchart of method steps associated with path normalization is shown. In summary, two main time values, designated DropTime and TotalTime, are determined. These values are used to determine two additional values, designated DropAng and Smax, that are used to more precisely designate a “drop off” point, or intermediate point along the path where a particular operation is performed or more precise positioning of the manipulator is desired, and to insure that no maxima (e.g., maximum performance attributes of the manipulator) are exceeded when the control strategy is being executed.

At 700, variables are initialized. More specifically, the total time to traverse the path (TotalTime), adjusted to account for move stacking and vector optimization, is set equal to zero (TotalTime=0) and step number two is selected (Step=2).

At 702, the time to traverse to the current step is added to the current value for TotalTime. More specifically, the segment times (Taj, Ta, Taj, Tss, Tdj, Td, Tdj) for the current step (previously adjusted to account for move stacking and vector optimization) are added to the time duration of all previous steps.

At 704, the method determines whether the current step is the intermediate “drop off” step (designated “DropPt”). If the current step is indicative of the drop off step, then the method continues at block 706. If the current step is not the drop off step, then the method continues at block 708.

At 706, the time to traverse the sequence of steps between an initial or “pick up” step and an intermediate “drop off” step is determined. This pick up-to-drop off time is designated DropTime and is set equal to the current total time value (DropTime=TotalTime).

At 708, the step number is incremented to the next step in the sequence (Step=Step+1).

At 710, the method determines whether there are any additional points in the path. If there are additional points in the path, the method returns to block 702. If there are no additional points in the path, then the method continues at block 712.

At 712, DropAng and Smax are detennined based on DropTime and TotalTime. DropAng is used to more precisely designate the drop off point relative to a virtual axis. A virtual axis is used to control the rate of move to path point execution within the path. A virtual axis may be thought of as a servo axis that has basic kinematic attributes (e.g., maximum velocity, acceleration, and deceleration) but does not have output signals or position feedback input. A virtual axis is a common method of controlling step execution timing and may utilize PCAM (programmable cam) tables and associated methodologies as is known by those skilled in the art. Smax is the maximum rotation rate about the virtual axis. Smax acts as a speed limit to insure that no maxima are exceeded when the control strategy is being executed.

Referring to FIGS. 8 and 9, a flowchart of method steps associated with generating a final array of path points is shown. The generation of the final array of path points is based on the “jerk pulse” arrays previously generated during the stacking and overlapping steps associated with block 100 (FIG. 3) and block 102 (FIGS. 4-6).

Starting with FIG. 8, the method steps associated with the generation of the final array of path points are depicted.

At 800, the axis number is initially set equal to zero.

At 802, initial values for various integration constants (Cp, Cv, Ca), time variables (T, T1), and the step number (Step) are established. More specifically, a position or displacement integration constant, designated Cp, is set equal to the vector end position for the first vector of the current axis (Cp=Pos(1, AxisID). A velocity integration constant (Cv) and an acceleration integration constant (Ca) are set equal to zero. A time value (T) is also set equal to zero. A time index value (Ti), which can be any positive integer, is set equal to one. In addition, step number two is selected (Step=2)

At 804, the time and time index values are updated. More specifically, the time and time index values may be incremented to another positive integer value based on the maximum jerk pulse value and the total time to traverse the path (TotalTime).

At 806, various variable values are set. This block is similar to block 304 except (1) automatic calculations are permitted for Pss, Pacc, and Pdec and (2) no time values are reset.

At 808, as in blocks 306, 528, and 602 the jerk pulse routine may be executed to update values in the jerk pulse array. The jerk pulse array and its current values may be accessed to provide data for subsequent steps.

At 810, an index value (i) is set equal to zero, a jerk pulse index for step k (Jk), where k is a step index value is set equal to J(i,0), a time duration value (Dr) is set equal to J(i,1), and an initial position of the current vector (Cpl) is set equal to a position (displacement) integration constant (Cp).

At 812, the index value is assessed. If the index value is less than seven, then the method continues at block 814. If the index value is not less than seven, then the method continues at block 822.

At 814, the step number is incremented to the next step.

At 816, the step number is compared to the total number of steps or points in the move path (PointCnt). If there are more points in the move path, then the method returns to block 804. If there are no more points in the move path, then the method continues at block 818.

At 818, the axis number is incremented.

At 820, the axis number is compared to the total number of axes (AxisCnt). If the axis number does not exceed the total number of axes, then the method returns to block 802. If the axis number exceeds the total number of axes (i.e., all axes have been checked), then this portion of the method terminates.

At 822, a time value (T) is compared to the duration value (Dr). If T is greater than Dr, then the method continues at 824. If T is not greater than Dr, then the method continues at block 826.

At 824, various parameter values are established. These include the position integration constant (Cp), a velocity integration constant (Cv), an acceleration integration constant (Ca). These values are updated using the formulas shown in block 824. In addition, the time value (T) is decreased by the magnitude of the duration value, the index value is incremented, and the jerk pulse value and duration value are updated.

At 826, the time index value (Ti) is assessed. If Ti is less than 720, then the method continues at block 828. If Ti is not less than 720, then the method continues at block 830.

At 828, the time index value (Ti) is incremented and a position offset value for vector overlapping (Cplx) is set equal to zero.

At 830, a member of an array of “optimized” path points is assessed. The member of the array of optiined path points is designated by Path(AxisID,Ti), where AxisID is the axis number and Ti is the time index. If Path(AxisID,Ti) is not equal to zero, then the method continues at block 832. If Path(AxisID,Ti) is equal to zero, then the method continues at block 834.

At 832, the position offset value for vector overlapping (Cplx) is updated. More specifically, the initial position of the current vector is subtracted from Path(AxisID,Ti).

At 834, a value is stored in the array of optimized path points. The member of the array that receives the value is again designated by Path(AxisID,Ti), which is calculated as a function of the expression shown in block 834. In addition, the time value is updated based on the time value and the TotalTime value.

At 836, the index value (i) is incremented. The method then returns to block 812.

Referring to FIG. 9, the method steps associated with generating a jerk pulse array are shown. These method steps constitute a recursive routine for optimizing moves along the move path and employ the maximum velocities and jerk pulse values when possible.

At 900, a Boolean variable designated Flip indicates whether to invert or “flip” another value from positive to negative or vice versa. More specifically, if Flip is false, then the sign of another value will not be changed. If Flip is true, then the sign of another value will be changed.

At 902, the move distance (Dist) along the selected axis (e.g., ΔX, ΔY, ΔZ etc.) is assessed to determine whether movement is desired in a positive or negative direction along the selected axis. More specifically, if Dist a negative value, then Flip is set equal to true at block 904 to indicate movement in a negative direction along the selected axis. If Dist is not negative, then Flip remains set to false and the method continues at block 906.

At 906, the move distance is set equal to its absolute value.

At 908, the move distance is assessed to determine whether it is greater than zero. If Dist is greater than zero, then the method continues at block 920. If Dist is not greater than zero, then Dist must equal zero (since Dist cannot be negative after block 906) and the method continues at block 910.

At 910, the axis maximum acceleration jerk value for the current move (Ja) and axis maximum deceleration jerk value for the current move (Jd) are set equal to zero.

At 912, the time durations and jerk pulse values for the current move are populated. The nomenclature for these values was previously discussed in association with Table D.

At 914, the variable Flip is assessed. If Flip is true (indicative of a move in a negative direction along the selected axis), then the method continues at block 916 where the sign of each non-zero time duration is “flipped” or inverted. If Flip is false (indicative of move in a positive direction along the selected axis), then this portion of the method ends at block 918.

At 920, a variable indicative of the velocity at time t [V(t)] is set equal to zero.

At 922, the method determines whether the velocity at time t is sufficiently close to the maximum velocity value (Vel) for the current move and selected axis. If V(t) is sufficiently close to Vel (e.g., the absolute value of the difference is not less than 0.001), then the method continues at block 912. If V(t) is not sufficiently close to Vel, then the method continues at block 924.

At 924, the method determines whether calculation of the velocity steady state time value (Pss) is permitted. If Pss is true, then a maximum velocity value is calculated at block 926. If Pss is false, the method continues at block 928.

At 926, the method determines whether calculation of the acceleration time value (Pacc) is permitted. If Pacc is true, then a maximum acceleration value is calculated at block 930. If Pss is false, the method continues at block 932.

At 932, the method determines whether calculation of the deceleration time value (Pdec) is permitted. If Pdec is true, then a maximum deceleration time value is calculated at block 934. If Pdec is false, the method continues at block 936.

At 936, values for Vt, Taj and Ta are determined as shown.

At 938, Ta is assessed. If Ta is less than zero, then the method continues at block 940 where Ta is set equal to zero and Taj is updated as shown. If Ta is not less than zero, then the method continues at block 942.

At 942, values for Tdj and Td are determined as shown.

At 944, Td is assessed. If Td is less than zero, then the method continues at block 946 where Td is set equal to zero and Tdj is updated as shown. If Td is not less than zero, then the method continues at block 948.

At 948, a straight line approximation of the velocity during time periods when acceleration is occurring (Iacc) is determined as well as a straight line approximation of the velocity during time periods when deceleration is occurring (Idec). A graphical representation of these straight line approximations is shown in FIG. 15.

At 950, Tss is assessed. If Tss is less than zero, then the method continues at block 952 where Tss is set equal to zero and Vel is updated as shown. If Tss is not less than zero, then the method returns to block 922.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of planning a path for a multi-axis machine, the method comprising:
specifying kinematic limits for each axis of the multi-axis machine;
breaking the path into a sequence of linear moves, each move within a three-dimensional space; and
deriving a jerk pulse array for each axis for each move in the sequence of linear moves;
wherein the jerk pulse array specifies a set of segments within each move.

2. The method of claim 1 wherein each jerk pulse array comprises seven segments.

3. The method of claim 2 wherein the seven segments include:
a positive acceleration jerk;
a constant acceleration dwell;
a negative acceleration jerk;
a constant velocity dwell;
a negative deceleration jerk;
a constant deceleration dwell; and
a positive deceleration jerk.

4. The method of claim 3 wherein the positive and negative acceleration jerks have a first duration time and the positive and negative deceleration jerks have a second duration time.

5. The method of claim 2 wherein each segment is defined by a duration time and a jerk value.

6. The method of claim 1 wherein the kinematic limits for each axis further comprise a maximum acceleration phase jerk and a maximum deceleration phase jerk.

7. The method of claim 1 wherein the kinematic limits for each axis further comprise a maximum velocity value and a maximum acceleration value for each axis.

8. The method of claim 1 wherein breaking the path into a sequence of linear moves further comprises constructing a table with each row corresponding to one move in the sequence of linear moves.

9. The method of claim 8 wherein each row includes an entry for vector overlap specifying overlap of motion with an adjacent move in the sequence of linear moves.

10. The method of claim 1 further comprising overlapping at least one move in the sequence of linear moves with a next move in the sequence of linear moves such that acceleration of at least one axis in the next move occurs at the same time as deceleration of at least one axis in a previous move, whereby energy is conserved.

11. The method of claim 10 wherein a constant amount of overlap is applied to each axis at a given path point to maintain common scaled time durations for each segment of the jerk pulse array.

12. A method of path planning comprising:
specifying axis parameters for each axis of a multiple axis machine;
specifying a closed path as a sequence of moves for the multiple axis machine;
specifying, for each pair of adjacent moves, a move overlap percentage;
aligning an acceleration profile for each axis for each move in the sequence of moves, the acceleration profile having an acceleration portion and a deceleration portion; and
overlapping, for at least one axis, the deceleration portion of a first move in the sequence of moves with the acceleration portion of a next move following the first move based on the move overlap percentage for the first move and the next move.

13. The method of claim 12 wherein each move is specified as a sequence of jerk segments, each jerk segment defined by a duration time and a jerk value.

14. The method of claim 12 wherein the step of overlapping further comprises overlapping the deceleration and acceleration portions for each axis by a constant amount for a specified move to maintain a common scaled duration time.

15. The method of claim 12 wherein the step of overlapping further comprises selecting an overlap amount for the acceleration and deceleration portions that avoid interference between the multiple axis machine and an object.

16. The method of claim 12 further comprising the step of normalizing the overlapped moves to determine a total time required to execute the sequence of moves.

17. The method of claim 16 further comprising generating a final array of path points based on a jerk pulse array derived for each axis for each move in the sequence of moves.

18. A computer-readable medium storing a program executable by a computer for planning a path for a multi-axis machine, the medium comprising:
a move stacking code segment for breaking the path into a sequence of linear moves;
a jerk pulse code segment for generating a jerk pulse array having data for a set of segments that define each move;
a move overlapping code segment for overlapping at least one move in the sequence of linear moves with a next move in the sequence of linear moves such that an acceleration of at least one axis in a next move occurs at the same time as deceleration of at least one axis in a previous move;
a path normalization code segment for normalizing the sequence of linear moves; and
a generating code segment for generating a final array of path points for each axis.

19. The method of claim 18 wherein the jerk pulse array further comprises duration time and jerk pulse values for each segment.

20. The method of claim 18 wherein the move overlapping code segment overlaps the deceleration and acceleration portions for each axis by a constant amount for a specified move.
